(19) United States
(12) Patent Application Publication
(10) Pub. No.: US 2007/0162510 A1
(43) Pub. Date: Jul. 12, 2007

(54) Delayed file virtualization

(75) Inventors: Charles T. Lenzmeier, Silverthorne, CO (US); Edward J. Praitis, Woodinville, WA (US); John Stephens, Redmond, WA (US); Michael J. Gallop, Sammamish, WA (US); RoseMarie FitzSimons, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/323,952

(22) Filed: Dec. 30, 2005

(51) Int. Cl. G06F 17/30

(52) U.S. Cl. 707/200

(57) ABSTRACT

Certain applications, especially legacy applications, try to write to areas of the system that require administrator privileges and hence fail to run successfully for users with lessened privileges. The disclosed system redirects certain file writes, i.e., globally impactful file writes to specific locations that require administrator privileges and would otherwise fail for others users, so as to allow the same file writes to succeed by redirecting them to happen in the context of the user, i.e., in a per-user virtualization location. In particular, virtualization only occurs when the application is actually going to write to the file, not just when file access is requested without an intention of writing to or otherwise actually altering the file. Following virtualization, applications are redirected to use the virtualized files. The system thus allows users to run applications that otherwise would not be enabled, and to maintain a higher level of security when doing so.

### BACKGROUND

Running user processes with an administrator access level is often not optimal for users. When processes run within the context of an administrative access level, they forfeit many of the security features provided by the operating system, especially when using a web browser or reading email. Yet despite this, currently many user accounts on computer systems are configured to have users login as the administrator.

Having users run applications as Least-Privileged User Account (“LUA”) is desired but is often a problem for certain applications. LUA users are those that can perform common computer tasks but typically cannot install programs or change system settings. LUA users typically do not have the authority to perform operations that can compromise system security. Corporations that have their users run as LUA are occasionally called upon to perform significant and costly work to make their applications run for LUA users. In some cases, the corporations have to loosen security, e.g., give users permission to write to areas that are typically off-limits for LUA, to allow applications to run as LUA, thus losing many of the benefits of running as LUA.

### SUMMARY

Certain applications, especially legacy applications, try to write to areas of the system that require administrator privileges and, lacking sufficient privilege, fail to run successfully for LUA users. The disclosed system redirects certain file writes, i.e., globally impactful file writes to specific locations that require administrator privileges and would otherwise fail for LUA users, so as to allow the same file writes to succeed by redirecting them to happen in the LUA context of the user, i.e., in a per-user virtualization location. However, such virtual files are only created upon actual file modifications or writes, not just file reads or opens (“delayed virtualization”).

Prior applications of the assignee of the present invention have disclosed methods for non-delayed virtualization, e.g., virtualization that occurs when a file is requested to just be opened. The current system discloses methods for delayed virtualization, in which rather than occurring at the time the file is requested to be opened, a virtual file is only created when the file is actually written to. Thus, the use of the term “delay” here is intended to mean that if virtualization actually occurs, it occurs later than it would in a non-delayed or immediate virtualization situation. Indeed, not all files planned for virtualization will actually have virtual files thus created in a delayed virtualization system.

Advantages may include one or more of the following. By only creating virtual files upon an actual write, performance is improved because virtual files are not created unnecessarily. This may be particularly important for applications such as antivirus programs and Windows® Media Player that have substantial “open-for-write” operations on files but end up not performing write operations on many of those files.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Additional advantages will become apparent from the description that follows, including the figures and claims.

### BRIEF DESCRIPTION OF THE DRAWINGS

FIG. 1 shows the logical placement of a virtual store within a computing system.

FIG. 2 shows a flow chart indicating a method used by the system.

FIG. 3 shows a computing system that may include the system.

### DETAILED DESCRIPTION

Throughout this specification, “file virtualization” generally refers to the act of transparently creating a virtual file that a user's application running with lessened privileges, such as a LUA user, and not administrator, may transparently access in lieu of accessing the corresponding non-virtual file. In particular, in many cases, the lack of administrator privileges may prevent the user's application from accessing the non-virtual file, and the act of attempting to do so will result in an error message. By allowing the user to access the virtual file instead, such errors are prevented.

In more detail, at the time of virtualization, a file virtualization filter copies the original file (the “global file”) to a location in a “virtual store” to create a “virtual file”. This virtual file is then accessed whenever a virtualization-enabled application opens the global file. If the filter creates the virtual file when the application opens the global file for write access, this is “non-delayed”, “immediate”, or “copy-on-open” virtualization. If the filter instead waits until the application actually writes to the file, this is “delayed” or “copy-on-write” virtualization. In other words, virtualization occurs when the application is actually going to write to the file, not just when file access is requested (i.e., the file is opened) without an immediate need to write to or otherwise actually alter the file.

In more detail, the default file system behavior when an application asks for write access to files, e.g., by using a file open flag such as FILE_GENERIC_WRITE, is to open the file, even though in many scenarios the application may not actually write to the file. When the user is running as LUA, and the user is denied access to a file due to lack of privilege, and the file is a candidate for virtualization, the system in part lessens or minimizes the set of files that get virtualized, so virtual files are only created when it is absolutely necessary, i.e. when the file write actually occurs. This eliminates unnecessary creation of virtual files. For example, sometimes a file is opened to record errors, but if no errors occur then the file is not actually written to. In some cases, a developer will code a procedure to first open all files that could potentially be needed by the procedure, even though most invocations of the procedure will not actually use all of those files. In these cases, and others, unused files might not be virtualized merely as a result of their being opened.

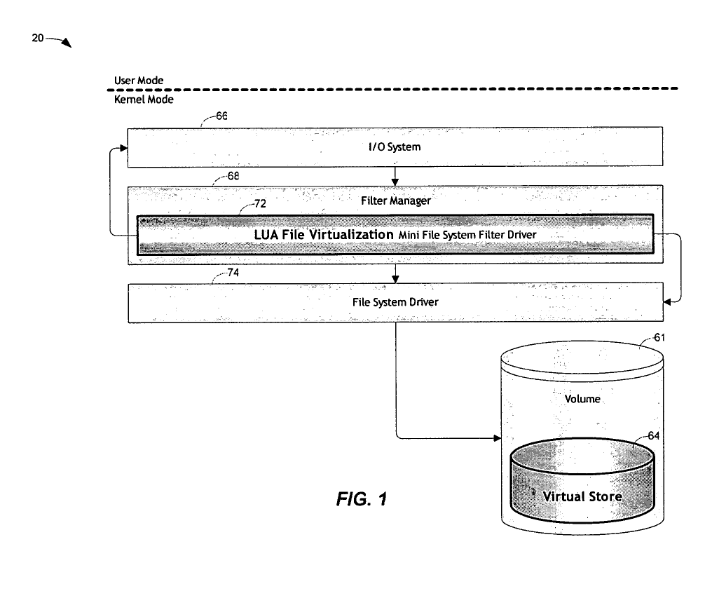

Referring to FIG. 1, a portion 20 of a computer system is shown. A volume 61, i.e., a specific data storage device, is shown having a virtual store 64, explained in more detail below. The volume 61 is accessed via a file system driver 74. The file system driver 74 accesses files from a filter manager 68 within which is a mini-file-system filter driver for LUA file virtualization 72. An I/O system 66 accesses the file system driver 74.

The virtual store 64 is a directory that is organized on a per-user and per-volume basis in the root directory. In other words, each volume has its own virtual directory for storing virtual files, and this directory is broken down into subdirectories for each user. The file and folder hierarchy may mimic that of the global file system.

If the virtual directory has already been created, the same may be available when the volume is available. Alternatively, the virtual directory may also be created dynamically upon demand, and is generally not roamed. In other words, the virtual directory is generally not available for server-based user profiles that are downloaded to a local computer when a user logs on.

Virtual stores may be created as needed per-volume within the root and may be partitioned per-user, e.g., by the security identification number “SID”. The appropriate security descriptors may be applied to each virtual directory or subdirectory to ensure the privacy and integrity of the user data. The same or similar security descriptors may be used as are known for user profile directories (account directories or “home” directories). As a user's virtual directory may have the same permissions as the user's profile directory, it may be fully accessible to applications and tools running in the context of the user. Virtualization is preferably not recursive; virtual stores may be excluded from virtualization if necessary or desired. Virtual namespaces, the root directory for a specific user's virtual file hierarchy within the virtual store, may be viewed as a logical file layer above the global layer. The following example shows the file layout for a virtual “WINDOWS\win.ini” file for a user:

| <Volume Root> | |
|---|---|
| +---System Volume Information | |
| \| | \---Virtual Store |

| | |
|---|---|
| \| | \---<Virtual Namespace> |

| | |
|---|---|
| \| | \---WINDOWS |

| | |
|---|---|
| \| | win.ini |
| \| | |
| \---WINDOWS | |

win.ini

Also shown in FIG. 1 is the logical separation of the user mode and the kernel mode within the operating system. User mode is the non-privileged processor mode in which application code, including protected subsystem code, executes. User mode applications cannot gain access to system data except by calling subsystem-supplied functions, which, in turn, call system services. Kernel mode is the privileged processor mode in which certain operating system executable code runs. A driver or thread running in kernel mode has low-level access to system memory and hardware.

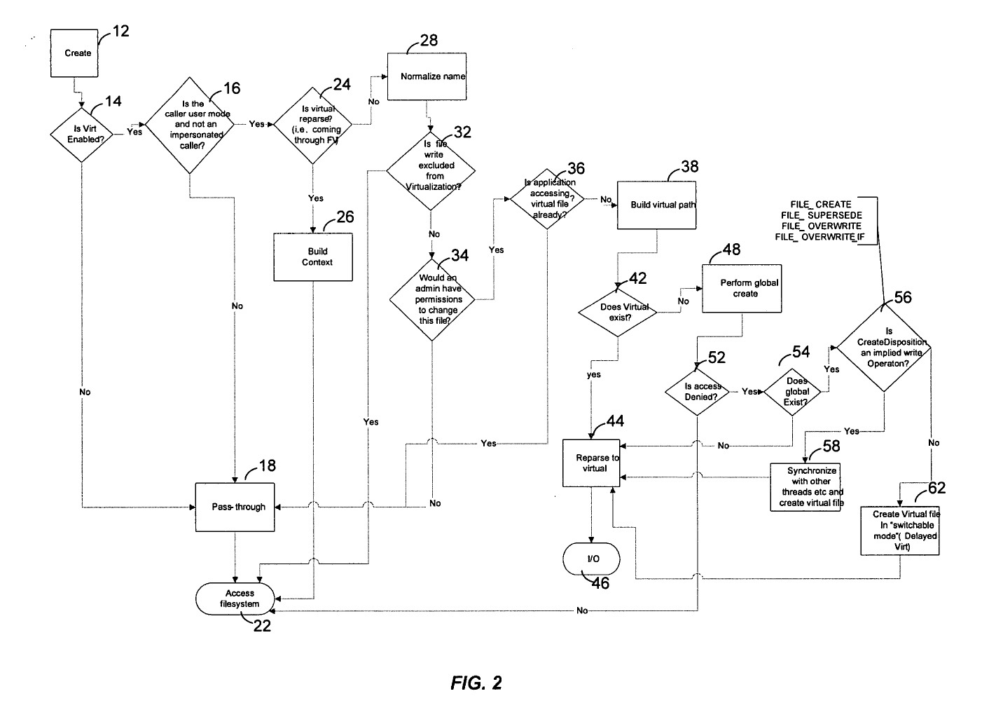

Steps of one embodiment will now be described. It is noted that much of the flowchart, up to step 54 and also including step 58, is also present in a non-delayed virtualization system. Steps 56 and 62 comprise much of the delayed virtualization functionality. Referring to FIG. 2, the method begins when a call is made by an application program or process to open a file or CREATE PROCESS (step 12). At this point, the application program is generally requesting write access to a file. Note that in this regard all file opens, whether for read access or write access, are referred to as “create” operations. Further, a caller is defined as any component running above the level of the file virtualization filter that perform file operations. The caller is usually the user application.

The next step “Is Virtualization Enabled?” (step 14) determines whether or not the scheme of file virtualization is enabled and usable by the operating system. The result of this step may be determined by a function call from a component within the kernel, i.e., the operating system, such as:

Return QueryVirtualizationMode(EffectiveToken);

This decision depends on the virtualization token, in this case “EffectiveToken”. Tokens such as Effective Token are token flags that are set per process. This flag may be defined, e.g., only for interactive logons, and may expose a new token information class, e.g., TokenVirtualization that allows callers to set and query this flag. If the token is set, file-writes that meet the criteria of being virtualized will be redirected to the virtual store 64. In another embodiment, virtualization may be restricted to primary token (instead of effective) and user mode callers.

In one embodiment, the default situation for a user running as LUA would be to have virtualization enabled upon start-up, creating a restricted token. This may be set at a system/domain/per-user level. In another embodiment, if virtualization is turned off globally (for the entire machine) then no virtualization occurs. In this case, no LUA object virtualization will be performed. Existing virtual files are ignored, and can only be accessed directly in the virtual store.

Virtualization may also be turned off for a specific application. For example, some applications are designed to be only run at the administrator level. Such applications may be marked in an application database as not using virtualization. That is, virtualization may be turned off for full token users, e.g., the local administrator and users elevated to administrator privilege. When an application is started, the application may query an application database to determine if the application is so marked. If so, virtualization is not enabled and the virtualization token is not set. If virtualization is off for a given process, the files already in the virtual store 64 may not be visible to that process, i.e., read-though to the virtual store 64 may not be afforded.

However it may happen, if virtualization is not enabled then program flow proceeds to pass-through (step 18) which accesses the filesystem as needed (step 22). In particular, pass-through (step 18) passes the request for file access to the FILESYSTEM without allowing direct access. In this case, if the user running as LUA attempts to access a file accessible only to administrator-level users, without a virtual file available to access instead, and there would be none if virtualization was not enabled, an error message would result.

If virtualization is enabled, however, a number of criteria may be checked to determine if the particular file is a proper candidate for virtualization and disposition in the virtual store 64.

First, if virtualization is enabled, then the system checks to see if the caller, i.e., the user application, is running in user mode as described above or is running in an impersonated profile (step 16). If the caller is in user mode, i.e., at an unprivileged access level, then the virtualization procedure may continue.

If the caller is not in user mode or is an impersonated caller, then the program again branches to pass-through (step 18) and further accesses the filesystem (step 22). In any case, as above, if the user running as LUA attempts to access a file accessible to users running with administrator access privileges, and a corresponding virtual file is not available to access instead, an error message results.

This “NO” branch from decision step 16 eliminates the security issues raised by impersonated and kernel mode callers. In particular, allowing virtualization for such users may allow global data to be overwritten; an act such callers ordinarily would not be allowed to do. For example, when a DLL is loaded under impersonation, such as in winlogon.exe processes, users may provide their own malicious virtual DLL and take control of the process. The current method prevents virtualization of system DLLs. In the case of kernel mode callers, drivers inspecting global data, including loading modules, may do so under impersonation. With virtualization, such callers may no longer be sure they are accessing the global version. For this reason as well, virtualization is only allowed for user mode calls.

The method then checks if the action is a re-parse (step 24). That is, when an application calls for a file write operation it generally initially calls for a file write operation on the global file. If the application has been re-parsed to a virtual file, however, then the remainder of the virtualization logic can be skipped, saving significant time. Thus, this step performs that check. In other words, this step is used to distinguish between a case of a direct open using the full virtual path (i.e., a file-open command with the full path such as “\Virtual Store\username\somefile”) and an open via the virtualization logic that has reparsed to the virtual file. If the action is a re-parse, then any necessary context for the virtual file is built (step 26) and the filesystem is accessed as before (step 22).

In this context, it is noted that the term reparse is used to mean that an application has been redirected to use a file different from the originally-intended file.

If the action is not a re-parse, then the process of virtualization continues. The file name may be normalized (step 28). In particular, the underlying file system filter driver 72 sets the short names for virtual files as the same as that for normal files. As the file system filter driver 72 is unaware of the relationship between the global and virtual directories, it may not synchronize the short names.

A difficulty may arise when a file having a short filename associated with a file in the global location may not match the equivalent short filename in the virtualized location. Moreover, if only a virtual file exists, and later a global file is created with a different long name but the same short name, then if the global file is virtualized, its virtual short name may differ from its global short name.

For example, a user may be running as LUA and the global file system location\program files\common files\appdir contains a file:

| Long File Name | Short File Name |
|---|---|
| This is test 1.txt | THISIS˜1.TXT |

If an application creates a virtual file in the same location, and if a global file has not been created for this specific user, then the short file name in the virtual folder will be the same as that in the global location although the long filenames are different.

The virtual location\program files\common files\appdir then contains a file:

| Long File Name | Short File Name |
|---|---|
| This is test 2.txt | THISIS˜1.TXT |

Certain rules help to resolve issues surrounding the handling of short file names. In particular, if an application requests file access, then the long file name should be used if possible. In such cases the long file name will always map to the correct location. In any case, virtualization should be ensured to occur on the correct volume, and to the same file, regardless of what name form is used to reference the same.

The next check is whether the file-write is excluded from virtualization (step 32). Certain filesperse are excluded from virtualization. In particular, operating system and other such files may be specifically excluded from virtualization on grounds of security and system stability. Files may be excluded from virtualization by setting an attribute on the global file, or by checking if the file is listed in an inclusion/exclusion criteria list or database.

For example, one criteria may be that if a virtualized file exists, it takes precedence over the global file unless the global file is an operating system file or other such file. Another criterion may be that only files that an administrator would have had privileges to change may be virtualized.

File virtualization should not result in additional security issues, e.g., via elevation of privileges. To this end, kernel mode calls and impersonated calls may be excluded from virtualization. Moreover, operating system and other such files may be excluded from virtualization, and only specific areas of the system where applications commonly write may be redirected.

In any case, if the file is excluded from virtualization, then the system passes through (step 18) to the filesystem as before.

The next check may be whether a user with heightened or administrator privileges would have had permission to change the file (step 34). If not, the test fails and the system passes through (step 18) to the filesystem as before. If so, then the file continues to be a proper candidate for virtualization and the next set of criteria may be checked.

Step 36 refers to whether the file has already been virtualized. In particular, this step focuses on whether the application is already directly accessing a virtual file in the virtual store. If the user is already directly accessing the virtual file in the virtual store, then no further virtualization is necessary and the system can continue to transparently access the virtual file via the filesystem (step 22). If the application is not directly accessing a virtual file in the virtual store, then the process continues to the creation of the virtual file. Note that step 36 is a check to see if the application is accessing the virtual store for the file, not a check to see if an appropriate file virtual already exists, which is the subject of a later step.

The first step in this creation is a building of a virtual path to the virtual file (step 38). This step connects the virtual file, to be created within the virtual store 64, with the application requesting creation or modification of the corresponding file.

The next step solves the problem of multiple creation of a same virtual file. Once the virtual path has been constructed, the virtual path (including filename) can be checked against the virtual store 64 to determine if a virtual file for that virtual path already exists (step 42). If the virtual file already exists, then the application can be reparsed to the virtual file (step 44). The I/O system 66 is then accessed as appropriate (step 46).

If there is no virtual file for the virtual path, i.e., if the “does virtual exist?” (step 42) test fails, then the “NO” branch is followed and a global file is created (step 48).

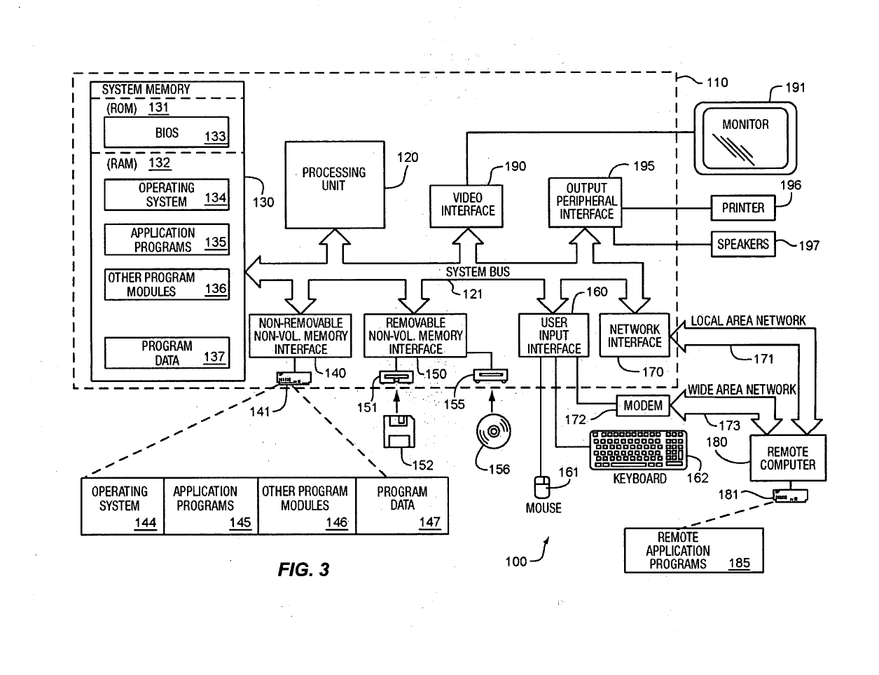

The next step is to determine if access to the global file is allowed or denied (step 52). If access to the global file is not denied, then the action is allowed to pass through to the filesystem, as no virtualization is necessary if a global file is allowed to be created or modified. If access is denied, i.e., no access to a global file is allowed, then the next test is to determine if a global file already exists (step 54). If the global file does not already exist, then the application program can reparse to the virtual file (step 44), and access is made to the I/O system 66, as described in more detail below in connection with FIG. 3.

The results of steps 42 through 54 are summarized in TABLE I.

TABLE I

| | | COULD | |
|---|---|---|---|
| CHECK OF | CHECK OF | ADMIN | |
| VIRTUAL | GLOBAL | CHANGE | |
| STORE | FILESYSTEM | FILE? | RESULT |
| FILE EXISTS | FILE EXISTS | YES | APPLICATION USES |
| | | | VIRTUAL FILE IN |
| | | | VIRTUAL STORE |
| FILE EXISTS | FILE DOES | N/A | APPLICATION USES |
| | NOT EXIST | | VIRTUAL FILE IN |
| | | | VIRTUAL STORE |
| FILE EXISTS | FILE EXISTS | NO | APPLICATION DOES |
| | | | NOT USE VIRTUAL |
| | | | FILE IN VIRTUAL |
| | | | STORE - PASS |
| | | | THROUGH TO FILE- |
| | | | SYSTEM |
| FILE DOES | FILE DOES | N/A | FILE IS A CANDIDATE |
| NOT EXIST | NOT EXIST | | FOR VIRTUALIZATION |
| FILE DOES | FILE EXISTS | NO | PASS THROUGH TO |
| NOT EXIST | | | FILE-SYSTEM |
| FILE DOES | FILE EXISTS | YES | FILE IS A CANDIDATE |
| NOT EXIST | | | FOR VIRTUALIZATION |

If a global file already exists, then a determination is made as to whether the call is to write to a file that is not an allowed operation for delayed virtualization (step 56). In more detail, “Is CreateDisposition an implied write operation?” (step 56) refers to certain cases where delayed virtualization may not happen. In these cases, an entire file is being completely overwritten or created with new content (an implicit write) and thus delayed virtualization is preferably not used. Such operations include the following (as denoted by their corresponding operation flags): FILE_CREATE, FILE_SUPERSEDE, FILE_OVERWRITE, FILE_OVERWRITE_IF, and the like. If the call is for such an operation, then a virtual file may still be created, but in a non-delayed fashion. Virtualization is immediate in those instances because there is an implied write operation in the next operation. In general, delayed virtualization may not occur upon write or other file-altering operations, or for those which change or replace attributes, file times, data, etc. and thus non-delayed virtualization occurs instead.

It is noted that in certain other cases the file is not actually changed and yet virtualization is again not delayed. For example, if a section object on a file is being mapped for write access, e.g., as if it were memory instead of a file, then a block of memory is reserved that can be changed. For these individual writes, delayed virtualization may or may not be employed. If not, then virtualization may occur immediately rather than when changes to memory occur.

Delayed virtualization may occur for operations that do not change the file or replace the same, such as file-open, file-open-if, and the like. In the former, if the file already exists, then the operation calls for opening it instead of creating a new file. If the file does not exist, the operation fails the requests and does not create a new file. In the latter, the operation calls for opening the file if it exists. If it does not, the operation creates the file.

In these delayed virtualization cases, however, a file object is generated that is referred to here, e.g., as the delayed virtualization file. However, it should be noted that this file object is and continues to be just a link or pointer to the global file until such time as actual virtualization occurs, at which point a copy of the global file is created in the user's virtual store (step 62). That is, if the virtual file is created through delayed virtualization, the virtual file is not initially created per se-just a handle or pointer to the global file is created. If there later occurs a reason to create the physical file (e.g., an actual write to the file), then all existing virtual handles are synchronized and switched over to use the virtual file. In other words, the handle provides a placeholder file object whose target can be switched. All operations to the placeholder file object can be redirected to the target. Initially, the target is the global file. When a write is made, the global file is virtualized (step 62) and the target is switched from the global file to the newly created virtual file. The application then reparses (step 44) to the so-created virtualized file.

FIG. 3 illustrates an example of a suitable computing system environment 100. The computing system environment 100 is only one example of a suitable computing environment and is not intended to suggest any limitation as to the scope of use or functionality of the system. Neither should the computing environment 100 be interpreted as having any dependency or requirement relating to any one or combination of components illustrated in the exemplary operating environment 100.

The system as described is operational with numerous other general purpose or special purpose computing system environments or configurations. Examples of well known computing systems, environments, and/or configurations that may be suitable include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The system may be described in the general context of computer-executable instructions, such as program modules, being executed by a computer. Generally, program modules include routines, programs, objects, components, data structures, etc. that perform particular tasks or implement particular abstract data types. The system and method may also be practiced in distributed computing environments where tasks are performed by remote processing devices that are linked through a communications network. In a distributed computing environment, program modules may be located in both local and remote computer storage media including memory storage devices.

With reference to FIG. 3, an exemplary system for implementing the system includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 3 illustrates operating system 134, application programs 135, other program modules 136, and program data 137.

The computer 110 may also include other removable/non-removable, volatile/nonvolatile computer storage media. By way of example only, FIG. 3 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 3, provide storage of computer readable instructions, data structures, program modules and other data for the computer 110. In FIG. 3, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 3. The logical connections depicted in FIG. 3 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 3 illustrates remote application programs 185 as residing on memory device 181. It will be appreciated that the network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The system described herein includes these and other various types of computer-readable storage media when such media contain instructions or programs for implementing the steps described below in conjunction with a microprocessor or other data processor. The system also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the system is operational with numerous other general purpose or special purpose computing system environments or configurations. The computing system environment is not intended to suggest any limitation as to the scope of use or functionality. Moreover, the computing system environment should not be interpreted as having any dependency or requirement relating to any one or combination of components illustrated in the exemplary operating environment. Examples of well known computing systems, environments, and/or configurations that may be suitable that may be used include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, computer 130 executes computer-executable instructions such as those illustrated in the figures to grant an application program access to a resource according to a privilege associated with the application program and with the resource.

The systems and methods illustrated in the figures and described herein may be implemented in software or hardware or both using techniques some of which are well known in the art.

The order of execution or performance of the methods illustrated and described herein is not essential, unless otherwise specified. That is, elements of the methods may be performed in any order, unless otherwise specified, and that the methods may include more or less elements than those disclosed herein.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

For example, the methods and techniques described here may be applied to a number of areas in which a virtual file is desired to be created within the context of a specific user and for a specific file. In particular, the technique of employing virtualized files that are only created when necessary may be used in combination with application isolation and other similar areas. As another example, the methods and techniques described here may be applied to partial virtualization for a specific application. In particular, certain files in an application may be virtualized while others are not virtualized.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of providing applications with virtual files to transparently stand in the place of corresponding restricted files, the method comprising:
receiving requests from applications to access restricted files, where the restricted files are to be accessed indirectly by accessing virtual files that correspond to respective restricted files, where the accessing of the virtual files is transparent to the applications;
and not creating virtual files for those requests until data is requested to be written to the restricted files by the corresponding applications

2. The method of claim 1, further comprising repeating the receiving and not creating steps for each subsequent request from an application to access the file, and if the access called for is to write to the file, then creating a virtual file in a virtual directory accessible by the user, the virtual file a copy of the file, and redirecting the application to access the virtual file.

3. The method of claim 1, further comprising determining whether the user is a user mode caller, and if the user is not a user mode caller, then not performing the receiving and not creating steps.

4. The method of claim 1, further comprising determining whether the file is an operating system or protected file, and if the file is an operating system or protected file, then not performing the receiving and not creating steps.

5. The method of claim 1, further comprising determining whether the file is a previously-created virtual file, and if the file is a previously-created virtual file, then not performing the receiving and not creating steps, and redirecting the application to access the previously-created virtual file.

6. The method of claim 1, wherein an access privilege level of a user is least-privileged user access.

7. The method of claim 2, wherein the virtual file is created in a per-user directory in a per user volume.

8. The method of claim 2, further comprising normalizing a filename of the virtual file.

9. The method of claim 1, further comprising determining whether the file would have been accessible for the application program if the user access privilege level were that of an administrator access privilege level, and if not, then not performing the receiving and not creating steps.

10. A computer-readable medium having computer-executable instructions for performing the steps recited in claim 1.

11. A method of communicating between a application process and an operating system process for providing an application process access to a file upon actual file writes by a user with access privileges that do not allow access to the file as determined by the operating system process, comprising:
a. Issuing, by the application process, a request from an application process to access a file, the request including file parameters including a filename;
b. Determining, by the operating system process, whether the file is accessible for the application process based on an access privilege level of the user;
c. Providing, by the operating system process to the application process, the file if the file is accessible for the application process;
d. if the file is not accessible for the application process, determining, by the operating system process, whether the access called for by the application process is access to open but not alter the file, or access to alter the file;
i. if the access called for is to alter the file, then responding to the request by creating, by the operating system process, a virtual file in a virtual directory accessible by the user, the virtual file comprising a copy of the file, and redirecting, by the operating system process, the application process to access the virtual file;
ii. if the access called for is to open but not alter the file, then responding to the request by delaying creation of the virtual file and instead creating, by the operating system process, a file object in a virtual directory accessible by the user, the file object comprising a pointer to or handle for the file, and redirecting, by the operating system process, the application process to access the file object.

12. The method of claim 11, further comprising repeating steps (b) through (d) for each subsequent request from a application process to access the file, and if the access called for is to alter the file, then synchronizing, by the operating system process, all the file objects, creating, by the operating system process, a virtual file in a virtual directory accessible by the user, the virtual file a copy of the file, and redirecting, by the operating system process, the application process to access the virtual file.

13. A method for providing an application program with virtual access to a file, comprising:
a. receiving a request from the application program to access the file;
b. determining whether the file is accessible for the application program based on an access privilege level of the user;
c. providing the application program with the file if the file is accessible for the application program;
d. if the file is not accessible for the application program, determining whether the access called for by the application program is to open but not alter the file or to alter the file;
i. if the access called for is to alter the file, then creating a virtual file in a virtual directory accessible by the user, the virtual file a copy of the file, and redirecting the application program to access the virtual file;
ii. if the access called for is to open but not alter the file, then delaying creation of the virtual file and instead creating a file object in a virtual directory accessible by the user, the file object a pointer to the file, and redirecting the application program to access the file object.

14. The method of claim 13, further comprising repeating steps (b) through (d) for each subsequent request from an application program to access the file, and if the access called for is to alter the file, then synchronizing all the file objects, creating a virtual file in a virtual directory accessible by the user, the virtual file a copy of the file, and redirecting the application program to access the virtual file

15. The method of claim 13, further comprising following step (a), determining whether the user is a user mode caller, and if the user is not a user mode caller, then not performing steps (b) through (d).

16. The method of claim 13, further comprising following step (a), determining whether the file is an operating system or protected file, and if the file is an operating system or protected file, then not performing steps (b) through (d).

17. The method of claim 13, further comprising following step (a), determining whether the file is a previously-created virtual file, and if the file is a previously-created virtual file, then redirecting the application program to access the previously-created virtual file.

18. The method of claim 13, wherein the access privilege level of the user is least-privileged user access.

19. The method of claim 14, wherein the virtual file is created in a per-user directory in a per user volume.

20. The method of claim 13, further comprising following step (a), determining whether the file would have been accessible for the application program if the user access privilege level were that of an administrator access privilege level, and if not, then not performing steps (b) through (d).
